(19) United States
(12) Patent Application Publication
(10) Pub. No.: US 2025/0132370 A1
(43) Pub. Date: Apr. 24, 2025

(54) MOLD-TYPE SECONDARY BATTERY POUCH CELL TERRACE FOLDING DEVICE

(71) Applicant: SK On Co., Ltd., Seoul (KR)

(72) Inventors: Ju Heon LEE, Daejeon (KR); Hong KIM, Daejeon (KR); Jong Mo PARK, Daejeon (KR); Hyung Woo SON, Daejeon (KR)

(21) Appl. No.: 18/922,394

(22) Filed: Oct. 22, 2024

(30) Foreign Application Priority Data
Oct. 23, 2023 (KR) 10-2023-0141946

(51) Int. Cl. H01M 10/04; H01M 50/105

(52) U.S. Cl. CPC H01M 10/0404; H01M 50/105

(57) ABSTRACT

Provided is a mold-type secondary battery pouch cell terrace folding device for folding an edge of a secondary battery pouch cell, which allows adjustments of a roller gap and a press unit gap by replacing a stopper, the device adjusting the gap by including: an upper mount including an upper roller disposed on the upper mount in a length direction; a lower mount including a lower roller disposed on the lower mount in the length direction; a support vertical to an upper surface of the lower mount and passing through the upper and lower mounts to move the upper mount vertically; and a block disposed between the upper mount and the lower mount to adjust a gap between the upper roller and the lower roller.

### CROSS-REFERENCE TO RELATED APPLICATIONS

This application claims priority under 35 U.S.C. § 119 to Korean Patent Application No. 10-2023-0141946, filed on Oct. 23, 2023, in the Korean Intellectual Property Office, the disclosure of which is incorporated herein by reference in its entirety.

### TECHNICAL FIELD

The following disclosure relates to a mold-type secondary battery pouch cell terrace folding device, and more particularly, to a mold-type secondary battery pouch cell terrace folding device for folding an edge of a sealed secondary battery pouch cell, which allows adjustments of a roller gap and a press unit gap by replacing a stopper.

### BACKGROUND

A pouch-type secondary battery may include an electrode assembly, a pouch case that accommodates the electrode assembly, and an electrode tab that extends from the electrode assembly and protrudes outward. The pouch case may include a case body that provides a space for storing the electrode assembly and a case cover that covers the case body, and usually be bonded by thermally compressing edges of the case body and the case cover together.

In the pouch-type secondary battery, the edge may be sealed, and the sealed edge may then be folded. A reason for folding the edge of the pouch-type secondary battery is to prevent corrosion from occurring in a sealed portion and to improve rigidity of the pouch. In addition, folding the edge of the secondary battery may reduce an overall size of the secondary battery, thereby minimizing a space occupied by the secondary battery.

In a folding process performed on the sealed portion of the pouch-type secondary battery, the sealed portion of the pouch may be folded while passing through a number of rollers mounted on upper and lower plates of a folding part. Therefore, it is very important to adjust a gap between the folding rollers to match a thickness of the sealed portion of the pouch. However, adjusting the gap between the folding rollers is currently performed by a worker manually setting the rollers. Therefore, the gap is unable to be adjusted to an accurate value, and its accuracy depends on the worker's ability.

### SUMMARY

An embodiment of the present disclosure is directed to suggesting a secondary battery pouch cell terrace folding device that may adjust a gap to match a thickness of a sealed portion of a battery pouch.

In one general aspect, provided is a secondary battery pouch cell terrace folding device, in which a terrace of a secondary battery pouch cell is folded as the terrace passes between an upper roller and a lower roller, the device including: an upper mount moved along a support as a lower plate and an upper plate are spaced apart from each other in a height direction by the support, and including the upper roller disposed on the upper mount in a length direction; a lower mount coupled to the lower plate, and including the lower roller disposed on the lower mount in the length direction; and a block disposed between the upper mount and the lower mount to adjust a gap between the upper roller and the lower roller.

The device may further include a connecting part disposed on the upper mount and connected to an external device to move the upper mount in the height direction.

The device may further include a stopper disposed on the support and disposed between the upper mount and the upper plate.

The at least one block may be in contact with a guide exposed between the upper mount and the lower mount, and fixed by a load of the upper mount.

In another general aspect, provided is a secondary battery pouch cell terrace folding device, in which a terrace of a secondary battery pouch cell is folded as the terrace passes between an upper roller and a lower roller, the device including: a lower plate coupled to a lower mount including the lower roller disposed on the lower mount in a length direction; an upper plate separated from the lower plate in a height direction by a support vertical to the lower plate; a guide passing through the upper plate, and having one end coupled to a connecting part of an upper mount including the upper roller disposed on the upper mount and the other end coupled to its head part in contact with an upper surface of the upper plate; and a block disposed between the upper surface of the upper plate and a lower surface of the head part to adjust a gap between the upper roller and the lower roller.

The device may further include a spring disposed on the guide, and having one end in contact with a lower surface of the upper plate and the other end in contact with an upper surface of the upper mount to apply a downward force to the upper mount.

The device may further include the connecting part disposed on an upper surface of the upper mount and connected to an external device to move the upper mount upward.

The device may further include: a protrusion disposed on an upper surface of the connecting part, having a shape of a handle having a space formed in its center, and having a through hole formed in an upper surface of the protrusion; a cylinder disposed on the upper surface of the upper plate; and a driving member disposed inside the protrusion, connected to the cylinder through the through hole, and having a diameter larger than the through hole.

The cylinder may be controlled for the driving member to press the connecting part.

The device may further include a sensor disposed on the upper plate and measuring a gap between the upper plate and the upper mount to detect the presence and thickness of the block.

The at least one block may be in contact with the guide exposed between the upper mount and the lower mount, and fixed by a load of the upper mount.

The block may include a detection hole having any of a different shape, number, or position based on its thickness, and a sensor may be disposed on the upper plate, and identify the detection hoe formed in the block to detect the presence and thickness of the block.

Other features and aspects will be apparent from the following detailed description, the drawings, and the claims.

### BRIEF DESCRIPTION OF THE DRAWINGS

FIG. 1 is a front view of a secondary battery pouch cell terrace folding device according to an embodiment of the present disclosure.

FIG. 2 is a front view of an embodiment where a block is inserted into the folding device according to the present disclosure.

FIG. 3 is an example showing the use of the folding device according to the present disclosure.

FIG. 4 is a front view of a secondary battery pouch cell terrace folding device according to another embodiment of the present disclosure.

FIG. 5 is a side view of the secondary battery pouch cell terrace folding device according to another embodiment of the present disclosure.

FIGS. 6 to 9 are exemplary views showing a driving sequence of the secondary battery pouch cell terrace folding device.

### DETAILED DESCRIPTION OF EMBODIMENTS

The present disclosure may be variously modified and have various embodiments, and specific embodiments are shown in the drawings and described in detail in the detailed description. However, it is to be understood that the present disclosure is not limited to the specific embodiments, and includes all modifications included in the spirit and scope of the present disclosure.

Unless defined otherwise, it is to be understood that all terms used in the specification including technical and scientific terms have the same meanings as those that are generally understood by those skilled in the art to which the present disclosure pertains.

It should be interpreted that terms defined by a generally used dictionary have the same meanings as the meanings in the context of the related art, and these terms should not be ideally or excessively formally interpreted unless explicitly defined in this application.

Hereinafter, embodiments of the present disclosure are described in detail with reference to the accompanying drawings. However, the embodiments are only exemplary, and the present disclosure is not limited to the specific embodiments exemplary described.

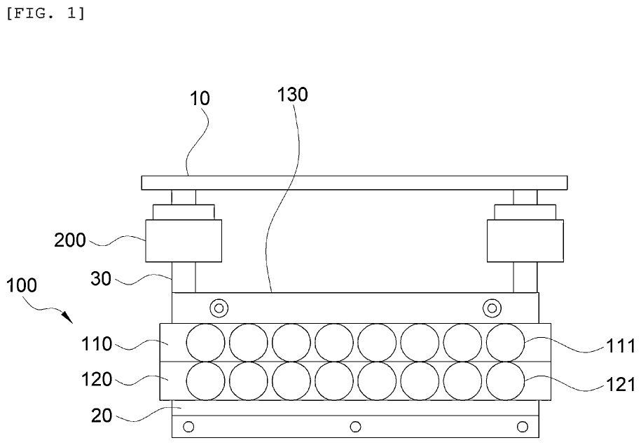

FIG. 1 is a front view of a secondary battery pouch cell terrace folding device according to an embodiment of the present disclosure. Referring to FIG. 1, provided is a secondary battery pouch cell terrace folding device, in which a terrace of a secondary battery pouch cell is folded as the terrace passes between an upper roller 111 and a lower roller 121, the device including: an upper mount 110 including the upper roller 111 disposed on the upper mount 110 in a length direction; a lower mount 120 including the lower roller 121 disposed on the lower mount 120 in the length direction; a support 30 vertical to an upper surface of the lower mount 120 and passing through the upper and lower mounts 110 and 120 to move the upper mount 110 vertically; and a block B disposed between the upper mount 110 and the lower mount 120 to adjust a gap between the upper roller 111 and the lower roller 121.

A lower plate 20 may be disposed for a lower surface of the lower roller 121 to be in contact with ground or a table. The support 30 may be vertical to an upper surface of the lower plate 20. An upper plate may be disposed on the support 30 to be level with the lower plate 20.

The lower mount 120 may have a fixed position by being coupled to the upper surface of the lower plate 20. The lower mount 120 may be passed through by the support 30. The plurality of rollers may be arranged on a front surface of the lower mount 120 in the length direction.

The upper mount 110 may be disposed between an upper plate 10 and the lower mount 120. In addition, the upper mount 110 may be passed through the support 30 and moved along the support 30 in a height direction, and its movement may be restricted in the length direction and a width direction. The plurality of upper rollers 111 may be disposed on the front surface of the upper mount 110 in the length direction. The upper roller 111 may be paired with the lower roller 121. The shape and position of each of the lower roller 121 and the upper roller 111 may be designed to fold the terrace of the secondary battery pouch cell, and the shape and position of each of the lower roller 121 and the upper roller 111 may be changed based on a folding method.

The upper roller 111 and the lower roller 121 may be spaced apart from each other to avoid contact and prevent damage when a lower surface of the upper mount 110 and the upper surface of the lower mount 120 come into contact with each other.

When folding the terrace of the secondary battery pouch cell, the upper mount 110 may maintain folding quality by fixing its position with a load. Here, if necessary, a weight may be disposed on the upper mount 110.

The upper mount 110 may further include a connecting part 130 connected to an external power device to be moved vertically. The connecting part 130 may be disposed on an upper surface of the upper mount 110. The upper mount 110 may be raised or lowered by being connected to a cylinder 400, a motor, or the like through a connecting member. In addition, the connecting part 130 may have the shape of a handle to be manually manipulated.

The secondary battery pouch cell terrace folding device may further include a stopper 200 disposed on a guide 300, and disposed between the upper mount 110 and the upper plate 10. The stopper 200 may be a component restricting a raised height of the upper mount 110, and prevent the upper mount 110 from being in direct contact with the upper plate 10 and damaged when the upper mount 110 is raised.

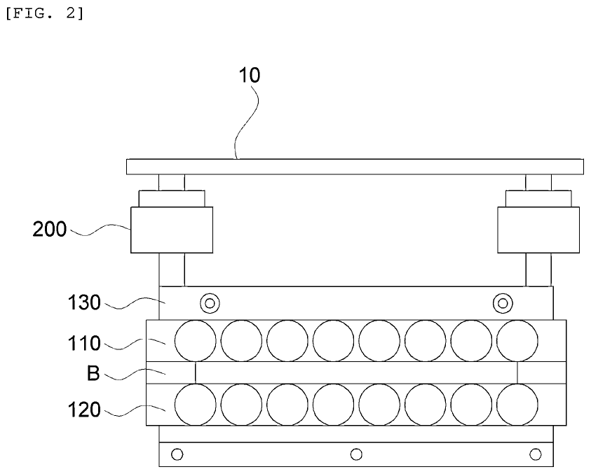

FIG. 2 is a front view of an embodiment where the block is inserted into the folding device according to the present disclosure. Referring to FIG. 2, the upper plate 10 and the lower plate 20 may be spaced apart from each other in the height direction, at least one guide 300 may be disposed between the upper plate 10 and the lower plate 20, and the upper plate 10 and the lower plate 20 may be connected to each other by the guide 300.

The lower mount 120 may be coupled to the upper surface of the lower plate 20. The upper mount 110 may be disposed on the lower mount 120 and moved vertically along the guide 300. The lower mount 120 may have the fixed position by being coupled with the lower plate 20. The upper mount 110 may be raised by receiving an external force through the connecting part 130 disposed thereon.

The connecting part 130 may be disposed on the upper mount 110 and connected to external equipment. The upper mount 110 may be raised to be spaced apart from the lower mount 120 by receiving the external force through the connecting part 130. The block B may be disposed between the upper mount 110 and the lower mount 120 while having a predetermined height. The upper mount 110 and the lower mount 120 may be spaced apart from each other by the height of the block B, and simultaneously, the lower roller 121 and the upper roller 111 may be spaced apart from each other by the height of the block B.

Here, the upper mount 110 may be raised by the external equipment. The stopper 200 may be disposed between the upper plate 10 and the upper mount 110 to prevent excessive raise of the upper mount 110. The stopper 200 may be disposed on the guide 300. The upper mount 110 may be made of an elastic material such as rubber capable of absorbing impact to prevent the raised upper mount 110 from being damaged by colliding with the upper plate 10.

After the insertion of the block B, the raised upper mount 110 may be lowered to come into contact with an upper surface of the block B. The upper mount 110 may be lowered by its self-weight or by a force of the external equipment. The lowered upper mount 110 may have a fixed position by its self-weight or by the continuous force of the external equipment. In addition, the upper mount 110 may have the fixed position by a coupling member (not shown) that couples the upper mount 110 and the lower mount 120 to each other. The coupling member may be disposed at the rear surface or side surface of the upper mount 110 and the lower mount 120 so as not to interfere with a folding process.

The block B may have a shape of a rectangular solid, a cylinder having horizontal upper and lower surfaces, or the like, and have a fixed position by at least one force among the self-weight of the upper mount 110, pressurization of an external device, and a coupling force of the coupling member. In addition, for convenience, the shape of the block B may be modified. For example, at least one block B may have a U-shape and an insertion part in the center, and be in contact with an outer surface of the guide 300 that is exposed between the upper mount 110 and the lower mount 120. The insertion part of the block B may correspond to a cross-sectional shape of the guide 300. The block B may be easily mounted or removed by using the insertion part, and the guide 300 may serve as a reference for positioning the block B, thus facilitating easier work.

In addition, at least one block may be disposed on the upper surface of the lower mount while being spaced apart from the guide. The block may be fixed by the load of the upper mount.

As another example, the block B may have a concave-convex portion on at least one of its upper surface in contact with the upper mount 110 and its lower surface in contact with the lower mount 120. Each of the upper mount 110 and the lower mount 120 may have a shape corresponding to the concave-convex portion of the block B. The block B may have the shape of a rectangular solid, a cylinder having horizontal upper and lower surfaces, or the like, which has the predetermined height, and a convex portion formed on its upper surface of the block B and a concave portion corresponding to a convex portion formed on the lower surface of the upper mount 110 may be coupled to each other. In this way, the position of the block B may be fixed to maintain a gap between the upper mount 110 and the lower mount 120, and the gap between the upper roller 111 and the lower roller 121 for a long time.

The folding device according to the present disclosure may further include a fixing member that fixes the block B and the upper mount 110 or the lower mount 120 to prevent the block B from being separated outward from its position. The fixing member may be coupled to an outer surface of the block B and an outer surface of the upper mount 110 or the lower mount 120 to prevent the separation of the block B.

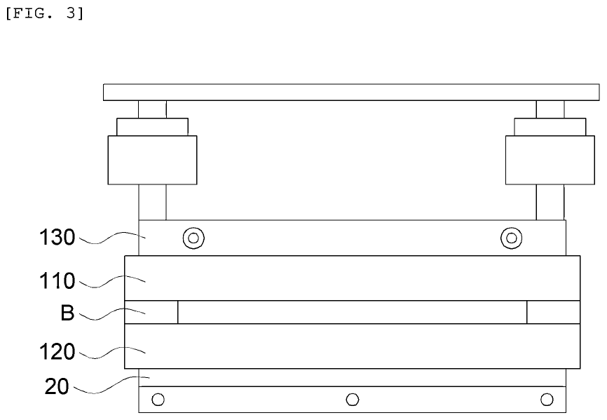

FIG. 3 is an example showing the use of the folding device according to the present disclosure. Referring to FIG. 3, the folding device according to the present disclosure may be used as a multipurpose pressing device by using the upper mount 110 and the lower mount 120 with the upper roller 111 and the lower roller 121 removed. The folding device may have its pressed height restricted by the block B disposed between the upper mount 110 and the lower mount 120. The shape, insertion, and fixing method of the block B are the same as those shown in the example of the folding device described above.

The folding device may be connected to the external device through the connecting part 130 disposed on the upper mount 110, and receive, from the external device, power required not only to be raised but also to be lowered. The external device may be, for example, the cylinder 400 having a piston 410. The cylinder may be controlled for a driving member to press the connecting part. A pressing force may be determined based on performance of the external device including the cylinder.

The upper mount 110 and the lower mount 120 may be interchangeable, and shapes of the lower surface of the upper mount 110 and the upper surface of the lower mount 120 may provide a change in shape to a surface of the material being pressed.

Hereinafter, the description further describes the embodiments of the present disclosure with reference to another specific embodiment. The embodiments merely exemplify the present disclosure and do not limit the scope of the appended claims. It is obvious to those skilled in the art that the embodiment may be variously changed and modified within the spirit and scope of the present disclosure, and these changes and modifications also fall within the scope of the appended claims.

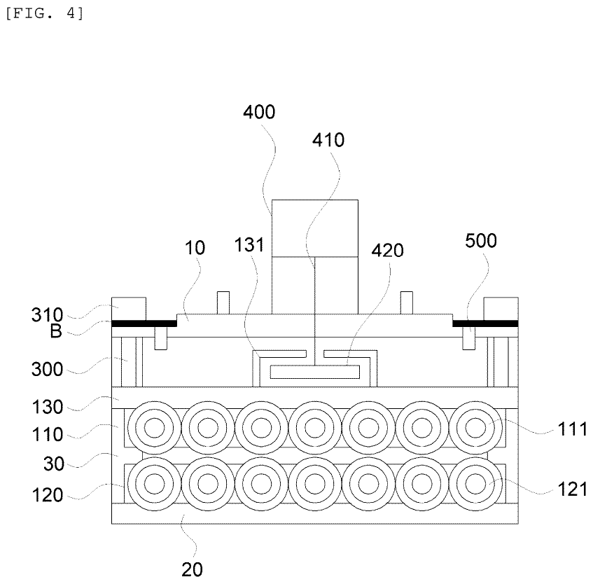

FIG. 4 is a front view of a secondary battery pouch cell terrace folding device according to another embodiment of the present disclosure. Referring to FIG. 4, provided is a secondary battery pouch cell terrace folding device, in which a terrace of a secondary battery pouch cell is folded as the terrace passes between an upper roller 111 and a lower roller 121, the device including: a lower plate 20 coupled to a lower mount 120 including the lower roller disposed on the lower mount 120 in a length direction; an upper plate 10 separated from the lower plate 20 in a height direction by a support 30 vertical to the lower plate 20; a guide 300 passing through the upper plate 10, and having one end coupled to a connecting part 130 of an upper mount 110 including the upper roller 111 disposed on the upper mount 110 and the other end coupled to its head part 310 in contact with an upper surface of the upper plate 10; and a block B disposed between the upper surface of the upper plate 10 and a lower surface of the head part 310 to adjust a gap between the upper roller 111 and the lower roller 121.

The upper plate 10 and the lower plate 20 may be spaced apart from each other in the height direction. The support 30 may have one end coupled to the upper plate 10, and the other end coupled to the lower plate 20. The lower mount 120 may be coupled to an upper surface of the lower plate 20 while having the lower roller 121.

The upper plate 10 may have a plurality of through holes, and the guide 300 may be inserted into the through hole while having a diameter corresponding to a diameter of the through hole. The head part 310 may be coupled to the top of the guide 300 while having a diameter larger than the through hole of the upper plate 10. The lower surface of the head part 310 may be in contact with the upper surface of the upper plate 10. The bottom of the guide 300 may be coupled to the connecting part 130 disposed between the lower mount 120 and the upper plate 10. A lower surface of the connecting part 130 may be coupled to the upper mount 110 having the upper roller 111.

The connecting part 130 may include a protrusion 131 protruding from its upper surface. The protrusion 131 may be connected to an external device disposed on the upper plate 10 and receive an upward force. A cylinder 400, which is an example of the external device, may include a piston 410 and a driving member 420 coupled to an end of the piston 410. The protrusion 131 may have a shape of a handle having a space for accommodating the driving member 420, and have a hole formed in its upper surface while having a diameter smaller than that of the driving member 420 and larger than or corresponding to that of the piston 410.

The piston 410 may pass through the upper plate 10 and be inserted into the hole of the protrusion 131. The driving member 420 may be coupled to the end of the piston 410 while having a diameter larger than the diameter of the hole in the protrusion 131. When the piston 410 is raised, the driving member 420 may transmit the upward force to the connecting part 130 by coming into contact with an inner upper surface of the protrusion 131. When the piston 410 is lowered, the driving member 420 may be spaced from the inner upper surface of the protrusion 131.

The upper mount 110, the upper roller 111, the guide 300, and the head part 310, which are directly or indirectly coupled to the connecting part 130 may be raised by an operation of the cylinder 400. Here, the connecting part 130 may have a horizontal movement restricted by the plurality of guides 300, and be moved in the height direction.

The block B may be raised to be disposed in a space between the head part 310 and the upper plate 10. The shape of the block B may allow the block B to be in contact with or surround the guide 300 as described above, and may be variously modified.

A sensor 500 may be disposed on the upper plate 10 and measure a raised height of the upper roller, the upper mount, or the connecting part 130. The height of the upper roller, the upper mount, or the connecting part may be changed when a jam occurs while performing folding work between the rollers. The sensor may detect the height change and detect the jam occurring during the work. The folding device according to the present disclosure may detect the jam and stop the work to prevent a major problem in advance.

In addition, the sensor 500 may prevent the connecting part 130 and the upper plate 10 from being damaged by excessively raising the connecting part 130. In addition, the sensor 500 may measure a position of the connecting part 130 to thus measure a thickness of the block B, the presence of the block, and the gap between the upper roller 111 and the lower roller 121.

In addition, the block may include a detection hole having a different shape, number, or position based on its thickness, and the folding device according to the present disclosure may include the sensor disposed on the upper plate and identifying the detection hole formed in the block to detect the presence and thickness of the block. For example, if the block has one detection hole formed for each unit of thickness (1 t), the sensor may identify the thickness of the mounted block through the identified number of detection holes. As another example, the detection hole may have a circular shape, a square shape, a triangular shape, or the like based on the thickness of the block, and the sensor may identify the thickness of the mounted block through the shape of the detection hole. As still another example, the detection holes may have different positions relative to the center of the block depending on the thickness of the block, and the sensor may identify the thickness of the block based on the position of the detection hole.

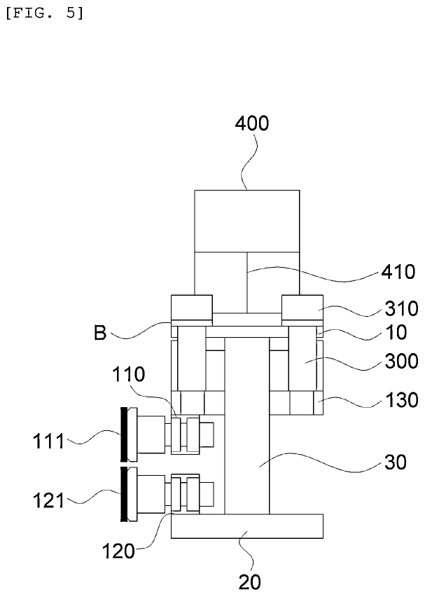

FIG. 5 is a side view of the secondary battery pouch cell terrace folding device according to another embodiment of the present disclosure. Referring to FIG. 5, the upper plate 10 and the lower plate 20 may be spaced apart from each other in the height direction by the support 30, and the lower mount 120 and the lower roller 121 may be disposed on the upper surface of the lower plate.

The plurality of guides 300 may pass through the upper plate 10 in the height direction. Each guide 300 may have the top on which the head part 310 is disposed, and the bottom which is coupled to the connecting part 130. The connecting part 130 may be coupled to the plurality of guides 300, and include a groove formed in its side surface that allows the connecting part 130 to be spaced apart from the support 30.

The upper mount 110 and the upper roller 111 may be disposed below the connecting part 130. The cylinder 400 may be disposed on the upper surface of the upper plate 10 and driven in the height direction to thus move the connecting part 130 is moved in the height direction, and the block B may be disposed between the head part 310 and the upper plate 10 to thus adjust the gap between the upper roller 111 and the lower roller 121.

The cylinder 400 may be raised to raise the upper roller 111, and if the cylinder 400 is lowered, the upper roller 111 may be lowered by its self-weight. In addition, the upper roller 111 may be lowered by tension of a spring disposed on the guide 300 and disposed between the upper plate 10 and the connecting part 130.

The connecting part 130, which is lowered by the self-weight or the tension of the spring, may have its lowered height restricted by the head part 310 and the block B. In more detail, the head part 310 may have the diameter larger than the diameter of the through hole in the upper plate 10, and be in contact with the upper surface of the upper plate 10, thus restricting a lowered height of the connecting part 130, the upper mount 110, or the upper roller 111. Here, their lowered heights may be reduced by a height of the block B, and the upper roller 111 may be further spaced apart by the heights of the lower roller 121 and the block B.

Each of the upper roller 111 and the lower roller 121 may have various diameters. Each of the upper roller 111 and the lower roller 121 may have the diameter larger than the height of the upper mount 110 or the lower mount 120, thus folding the wide terrace.

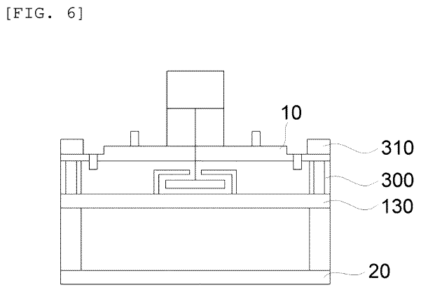

FIGS. 6 to 9 are exemplary views showing a driving sequence of the secondary battery pouch cell terrace folding device. For the convenience of description, the description is provided based on the position of the connecting part while omitting the upper mount, the lower mount, the upper roller, and the lower roller. The gap between the upper roller and the lower roller may be changed based on a change in a gap between the connecting part and the lower plate. FIG. 6 shows an initial stage. The head part 310 and the upper plate 10 may come into contact with each other. The connecting part 130 and the lower plate 20 may be closest to each other. The connecting part may be lowered by a load of the connecting part and the spring disposed on the guide 300.

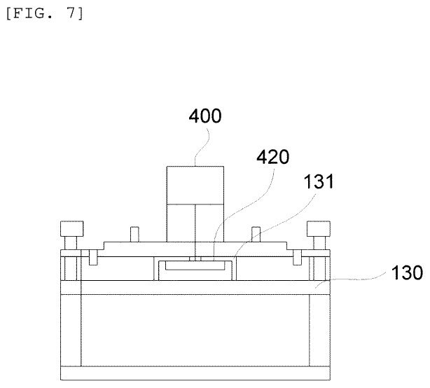

FIG. 7 shows a raising stage. The connecting part 130 may be connected to the cylinder 400 disposed on the upper plate, and raised by the operation of the cylinder. In detail, the protrusion 131 may be disposed on the connecting part, and the driving member 420 disposed inside the protrusion may be connected to the cylinder. The member, the protrusion, and the connecting part may be raised together by the operation of the cylinder.

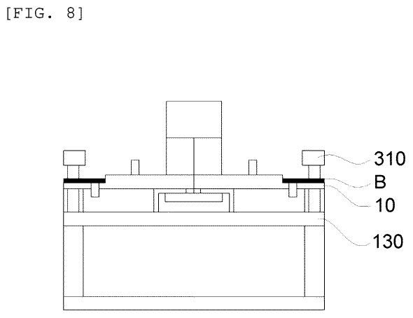

FIG. 8 is a block placement step. The connecting part 130 may be raised by the cylinder, and the guide coupled to the connecting part may also be raised. The head part 310 disposed on the top of the guide may be spaced apart from the upper plate 10. The block B may be disposed in a space where the head part 310 and the upper plate 10 are spaced apart from each other to thus adjust the lowered height of the connecting part. The block may be in contact with or surround the guide exposed between the head part and the upper plate.

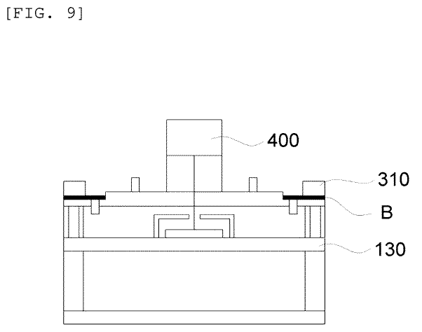

FIG. 9 shows a lowering stage. The member may be lowered by the lowering operation of the cylinder 400, and the guide and the connecting part 130 may be lowered. Here, the head part 310 may also be lowered, and come into contact with an upper surface of the disposed block B. The separation gap between the connecting part and the lower plate may be further increased by the height of the block. Here, the connecting part may have a fixed position by the continuous lowering force exerted by the spring disposed on the guide.

As set forth above, the secondary battery pouch cell terrace folding device according to the embodiments in the present disclosure may perform the accurate adjustments of the folding roller gap and the press gap within the machining tolerance.

The folding device according to the present disclosure may also be applicable to the adjustments of not only the folding roller gap but also the cylinder gap or the press gap.

The folding device according to the present disclosure may also accurately adjust the folding roller gap in response to the thickness deviation of the sealed portion of the pouch.

The folding device according to the present disclosure may also reduce a downtime or a defect rate, which is caused by the inaccurate adjustment of the folding roller gap and the press gap.

The folding device according to the present disclosure may also detect the pouch jamming immediately through the sensor installed thereon, thereby preventing a fire caused by the equipment operation while the pouch is jammed.

The folding device according to the present disclosure may also detect the presence and thickness of the installed stopper or the block, thereby preventing a mistake that may occur when adjusting the folding roller gap.

The content described above is only an example to which a principle of the present disclosure is applied, and may further include another configuration within the scope of the present disclosure.

What is claimed is:

1. A secondary battery pouch cell terrace folding device, in which a terrace of a secondary battery pouch cell is folded as the terrace passes between an upper roller and a lower roller, the device comprising:
an upper mount moved along a support as a lower plate and an upper plate are spaced apart from each other in a height direction by the support, and including the upper roller disposed on the upper mount in a length direction;
a lower mount coupled to the lower plate, and including the lower roller disposed on the lower mount in the length direction; and
a block disposed between the upper mount and the lower mount to adjust a gap between the upper roller and the lower roller.

2. The device of claim 1, further comprising a connecting part disposed on the upper mount and connected to an external device to move the upper mount in the height direction.

3. The device of claim 1, further comprising a stopper disposed on the support and disposed between the upper mount and the upper plate.

4. The device of claim 1, wherein the at least one block is in contact with a guide exposed between the upper mount and the lower mount, and fixed by a load of the upper mount.

5. A secondary battery pouch cell terrace folding device, in which a terrace of a secondary battery pouch cell is folded as the terrace passes between an upper roller and a lower roller, the device comprising:
a lower plate coupled to a lower mount including the lower roller disposed on the lower mount in a length direction;
an upper plate separated from the lower plate in a height direction by a support vertical to the lower plate;
a guide passing through the upper plate, and having one end coupled to a connecting part of an upper mount including the upper roller disposed on the upper mount and the other end coupled to its head part in contact with an upper surface of the upper plate; and
a block disposed between the upper surface of the upper plate and a lower surface of the head part to adjust a gap between the upper roller and the lower roller.

6. The device of claim 5, further comprising a spring disposed on the guide, and having one end in contact with a lower surface of the upper plate and the other end in contact with an upper surface of the upper mount to apply a downward force to the upper mount.

7. The device of claim 5, further comprising the connecting part disposed on an upper surface of the upper mount and connected to an external device to move the upper mount upward.

8. The device of claim 7, further comprising:
a protrusion disposed on an upper surface of the connecting part, having a shape of a handle having a space formed in its center, and having a through hole formed in an upper surface of the protrusion;
a cylinder disposed on the upper surface of the upper plate; and
a driving member disposed inside the protrusion, connected to the cylinder through the through hole, and having a diameter larger than the through hole.

9. The device of claim 8, wherein the cylinder is controlled for the driving member to press the connecting part.

10. The device of claim 5, further comprising a sensor disposed on the upper plate and measuring a gap between the upper plate and the upper mount to detect the presence and thickness of the block.

11. The device of claim 5, wherein the block includes a detection hole having a different shape, number, or position based on its thickness, and
a sensor is disposed on the upper plate, and identifies the detection hole formed in the block to detect the presence and thickness of the block.

12. The device of claim 5, wherein the at least one block is in contact with the guide exposed between the head part and the upper plate, and fixed by a load of the upper mount.
